(19) United States
(12) Patent Application Publication
(10) Pub. No.: US 2011/0271988 A1
(43) Pub. Date: Nov. 10, 2011

(54) Dual Pressure Spray Arm Assembly with Diverter Valve

(75) Inventors: Roderick MacWilliam, Arvada, CO (US); Michael W. Mingee, Centennial, CO (US)

(73) Assignee: Mark VII Equipment Inc., Arvada, CO (US)

(21) Appl. No.: 13/102,420

(22) Filed: May 6, 2011

Related U.S. Application Data
(60) Provisional application No. 61/332,628, filed on May 7, 2010.

(51) Int. Cl. B08B 3/00; F16K 11/065

(52) U.S. Cl. 134/123; 137/511

(57) ABSTRACT

A pivotable, dual pressure spray arm assembly has at least one high-pressure nozzle and at least one low-pressure nozzle. A single fluid conduit transports fluid through a pivot mount to the spray arm. A diverter valve mounted on the spray arm includes an inlet configured to alternately receive a high-pressure fluid and a low-pressure fluid from the single fluid conduit, a first outlet configured to distribute the high-pressure fluid to the high-pressure nozzles, and a second outlet configured to distribute the low-pressure fluid to the low-pressure nozzles. The diverter valve automatically switches fluid flow between the first and second outlets in response to the fluid pressure received at the inlet.

### CROSS REFERENCE TO RELATED APPLICATIONS

This application claims priority under 35 U.S.C. §119(e) to U.S. provisional patent application Ser. No. 61/332,628, filed on 7 May 2010, which is incorporated by reference herein in its entirety.

### TECHNICAL FIELD

The embodiments disclosed herein relate generally to hydraulic valves, and more particularly, to a dual pressure hydraulic valve that may be employed in an apparatus for washing automotive vehicles.

### BACKGROUND

The washing of automotive vehicles has been automated for some years with various types of apparatus in the art for washing vehicles. For example, there are overhead type car wash systems where a bridge is moved back and forth along the length of the car while the car remains stationary. A vehicle in such an overhead type wash system might first encounter a pre-soak treatment in which soap or another chemical for breaking down dirt or film on the surface of the car is first applied, and then a high-pressure wash, in which the treated dirt and film is removed from the vehicle. Thereafter, the overhead type car wash may apply a chemical to the vehicle to prepare the vehicle for receiving a rinse and wax solution and subsequently dry the vehicle for removing excess water and treating fluids.

Some overhead type car washes may utilize a manifold for creating a moveable spray arch that travels around the perimeter of the vehicle to apply fluids at both high and low-pressures. These fluids may be, for example, the low-pressure pre-soak solution and high-pressure fluid for removing the pre-soak solution. Typically, the low-pressure solution and the high-pressure fluid are distributed by a single fluid line through the same manifold or two concentric fluid lines supplying two manifolds via a dual-port swivel. However, such fluid distribution mechanisms are impractical. For example, distributing the high and low-pressure fluids through the same manifold may require a purge cycle to clean the manifold between each solution application, which increases the time required to wash a vehicle and reduces revenue for a car wash owner. Additionally, concentric, dual-port swivel fittings for fluid lines are typically costly to manufacture, repair, and replace. Further, distributing both high and low-pressure fluids through the same set of nozzles compromises wash quality as different nozzle designs are better at spraying low-pressure fluids than nozzles designed for spraying high-pressure fluids.

The information included in this Background section of the specification, including any references cited herein and any description or discussion thereof, is included for technical reference purposes only and is not to be regarded subject matter by which the scope of the invention is to be bound.

### SUMMARY

Embodiments of a car wash apparatus may be part of an overhead or inverted-L type system car wash, which moves a spray arm around the perimeter of a stationary automobile in a plurality of passes to alternately apply both low-pressure and high-pressure fluid sprays to wash an automobile.

In one implementation an apparatus for washing a vehicle includes a movable platform and a pivotable spray arm assembly mounted to the movable platform. The spray arm assembly may include at least one high-pressure nozzle and at least one low-pressure nozzle. The apparatus may further include a diverter valve that includes an inlet configured to alternatingly receive a high-pressure fluid and a low-pressure fluid, a first outlet configured to distribute the high-pressure fluid, and a second outlet configured to distribute the low-pressure fluid. A first valve is placed between the inlet and the first outlet and changes from an open state to a closed state upon a change in fluid pressure. A second valve is placed between the inlet and the second outlet and changes from a closed state to an open state upon the change in fluid pressure.

In another implementation a diverter valve has a valve body including an inlet configured to alternatingly receive a high-pressure fluid and a low-pressure fluid, a first outlet configured to distribute high-pressure fluid, and a second outlet configured to distribute low-pressure fluid. The diverter valve also has a first valve fluidly coupled to the inlet and the first outlet and a second valve fluidly coupled to the inlet and the second outlet. The first valve is configured to close when the second valve is open and the second valve is configured to close when the first valve is open.

In a further implementation a diverter valve includes a valve body, an inlet configured to alternatingly receive a high-pressure fluid and a low-pressure fluid, a first outlet configured to distribute high-pressure fluid, and a second outlet configured to distribute low-pressure fluid. The diverter valve further includes a first valve including an inlet fluidly coupled to the inlet of the valve body and an outlet fluidly coupled to the first outlet, and a second valve including an inlet fluidly coupled to the inlet of the valve body and an outlet fluidly coupled to the second outlet. The first valve is configured to open and the second valve is configured to close if a high-pressure fluid is received at the inlet of the valve body, and the first valve is configured to close and the second valve is configured to open if a low-pressure fluid is received at the inlet of the valve body.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

FIG. 1 is a front elevation view of an overhead car wash system incorporating one embodiment of a dual pressure spray arm assembly.

FIG. 2 is an isometric view of the embodiment of the dual pressure spray arm assembly shown in FIG. 1.

FIG. 3 is a partial isometric view of the embodiment of the dual pressure spray arm assembly shown in FIG. 1.

FIG. 4 is another partial isometric view of the embodiment of the dual pressure spray arm assembly shown in FIG. 1.

FIG. 5 is a schematic diagram of the operation of an embodiment of a diverter valve that may be used in conjunction with the dual pressure spray arm assembly shown in FIG. 1.

FIGS. 6A and 6B are cross-sectional views of embodiments of normally closed and normally open poppet valves that may be used in conjunction with a diverter valve operating as illustrated in FIG. 5.

FIGS. 7A and 7B are schematic diagrams of the operation of another embodiment of a diverter valve that may be used in conjunction with the dual pressure spray arm assembly shown in FIG. 1.

FIG. 8 is a partial cut-away view of an embodiment of a check valve that may be used in conjunction with a diverter valve operating as illustrated in FIGS. 7A and 7B.

FIGS. 9A and 9B are cross-sectional views of an embodiment of a burst valve (or velocity fuse) that may be used in conjunction with a diverter valve operating as illustrated in FIGS. 7A and 7B, as taken along line 9-9 of FIG. 3.

### DETAILED DESCRIPTION

Implementations of a car wash apparatus may include a spray arm having a diverter valve that includes a single inlet for receiving high and low-pressure fluids and two outlets. One of the outlets of the valve may be configured to distribute high-pressure fluid, while the other outlet may be configured to distribute low-pressure fluid.

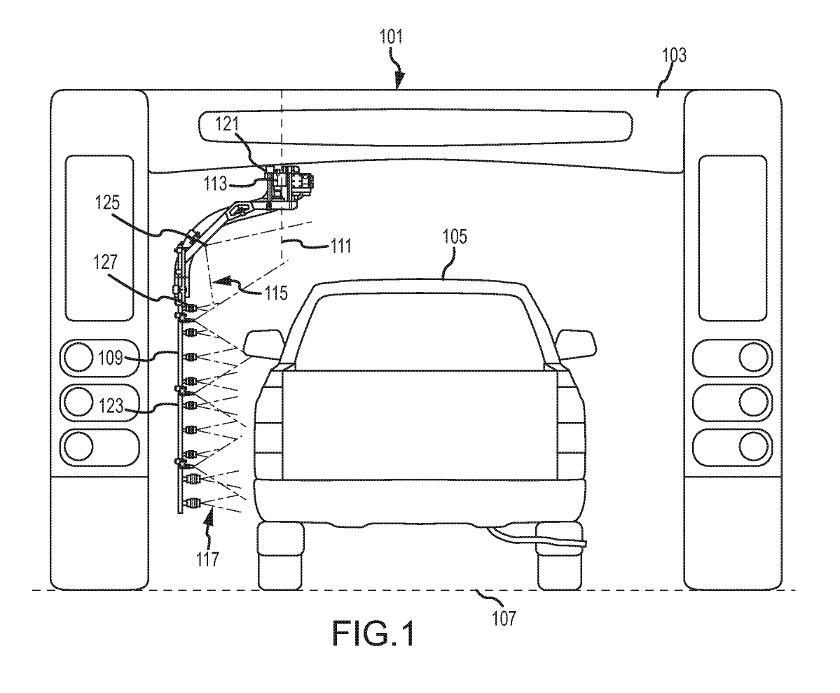

FIG. 1 shows an exemplary car wash apparatus 101. The apparatus 101 includes an overhead gantry component 103 or bridge that is moved back and forth along the length of a stationary automobile 105. The car wash apparatus 101 may further define a parking area 107 beneath the apparatus 101. Once inside the overhead type car wash apparatus 101, the automobile 105 may remain stationary in the parking area 107 throughout various car wash cycles.

The car wash apparatus 101 may further include a rotatable or pivotable spray arm assembly 109 for applying a pre-soak solution 115 to chemically break down grime, film or other material that might be on the surface of the vehicle 105, as well as a high-pressure water wash 117 that removes the pre-soak solution 115 along with any film, grime or the like that was loosened with the pre-soak solution 115. As will be further described below, the rotatable arm assembly 109 may pivot around the longitudinal axis 111 of the arm shaft 113 to apply these high and low-pressure fluids 117, 115. In some embodiments, the pre-soak solution 115 may be in a liquid-foam state, and the high-pressure fluid may be water. In other embodiments, both the low and high-pressure fluids 115, 117 may be in a liquid and/or foam state. The arm assembly 109 may be fully or partially encased in a housing (not shown).

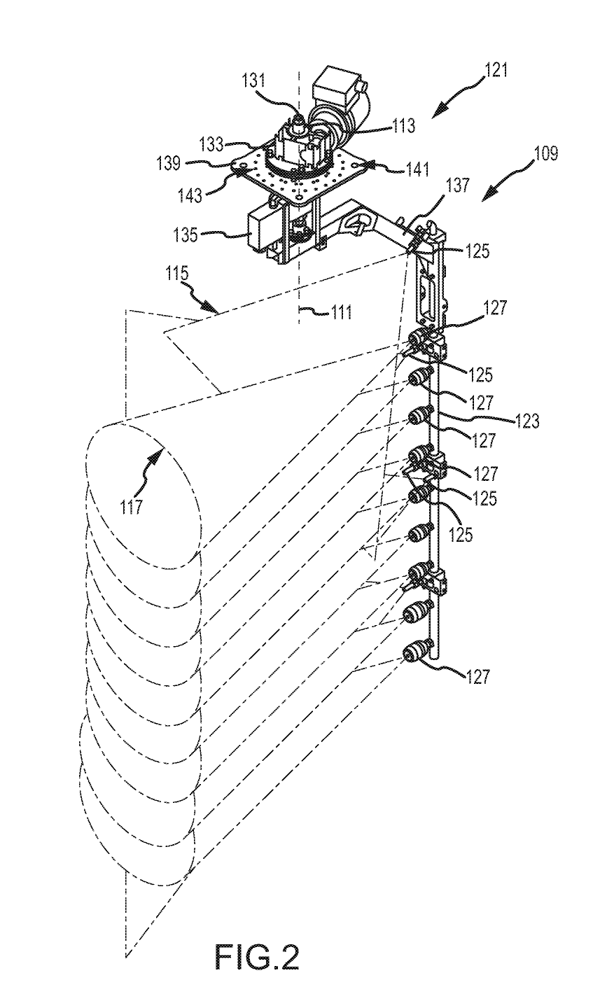

As shown in FIGS. 1-4, the rotatable arm assembly 109 may include a movable platform 121 that may be mounted to the overhead gantry 106 of the car wash, as well as a nozzle assembly 123 including a plurality of nozzles 125, 127. In some embodiments, the rotatable arm assembly 109 may move along the perimeter of the vehicle, e.g., front to back by movement of the gantry 106 and side-to-side along a trolley (not shown) mounted to the underside of the gantry 106. During operation, the nozzle assembly 123 may be positioned adjacent the parked vehicle 105 with the nozzles 125, 127 facing the vehicle 105. The nozzle assembly 123 may include a first set of low-pressure nozzles 125 for applying the pre-soak solution 115, and a second set of high-pressure nozzles 127 for applying the high-pressure water wash 117. As is shown via the dashed lines in FIGS. 1 and 2, the individual nozzles 125, 127, the high-pressure nozzles 127 may have a different spray configuration than the low-pressure nozzles 125 as illustrated by the dashed lines. For example, the high-pressure nozzles 127 may have a narrower, conical spray area 117, and the low-pressure nozzles 125 may have a wider, flat spray area 115. Other embodiments may include nozzles having other spray patterns.

In addition to the high and low-pressure nozzles 127, 125 described above, some embodiments of the car wash system 100 127, 125 may also include other nozzles for applying a wax or pre-wax solution to the car. These nozzles may be mounted within the overhead gantry components 106. Alternatively, the low-pressure nozzles 125 may additionally be used to spray the pre-wax and wax solutions onto the car 105. A water rinse may be run through the low-pressure nozzles 125 between application of different cleaning or waxing fluids in order to clean the fluid lines and the nozzles 125. Additionally, the car wash apparatus 101 may further include a blow dryer (not shown) so that as the vehicle emerges from the car wash, it may be dried.

FIGS. 2-4 illustrate an embodiment of a rotatable spray arm assembly 109 that may be used in conjunction with an overhead-type car wash apparatus 101. In one embodiment, the main components of the spray arm assembly 109 may include an arm assembly inlet portion 131, a motor assembly 133, a diverter valve 135, a mounting arm 137, and a nozzle assembly 123. These components will be described in further detail below.

The spray arm assembly 109 may be configured to pivot relative to the movable platform. In one embodiment, the spray arm assembly 109 may include an arm shaft 113 configured to enable pivoting or rotation of the assembly 109 around the longitudinal axis 111 of the arm shaft 113. Rotation of the arm shaft 113 may be driven by a motor 133 coupled to the arm shaft 113. As shown, the arm shaft 113 may be hollow and may extend vertically downward, concentric with and surrounding an arm assembly inlet 131 for a fluid conduit, through the rotation motor 133, to a bottom end 138 that is securely fastened to the mounting arm 137. Accordingly, the mounting arm 137 may rotate with the shaft 113 about the longitudinal axis 111 of the shaft 113. The motor 133 may be coupled to an appropriate power source for driving the motor 133, and may include a wheel, gear linkage, transmission, or other driving mechanism for rotating the arm shaft 113 about its longitudinal axis 111.

Referring to FIGS. 2-4, the arm assembly 109 may receive fluid through an arm assembly inlet 131 configured for fluid communication with a fluid distribution conduit (not shown) on the gantry 103 (shown in FIG. 1). The fluid distribution conduit may be, for example, a tube, hose, or other conduit capable of distributing fluid from a fluid source to the arm assembly inlet 131. In one embodiment, the fluid distribution conduit may be configured to distribute different types of fluid at different pressure levels. For example, the fluid distribution conduit may be configured to alternatively distribute a high-pressure fluid having a pressure greater than or equal to approximately 120 pounds per square inch (“PSI”) and a low-pressure fluid having a pressure less than or equal to approximately 120 PSI. In some embodiments, the fluid distribution conduit may be configured to distribute a high-pressure fluid having a pressure of up to 1,200 PSI. The high-pressure fluid may be water or some other rinsing fluid, and the low-pressure fluid may be a pre-soak solution.

The motor 133 may be supported by a motor mount plate 139, which may be mounted to a trolley (not shown) that travels laterally along the overhead gantry 103 of the car wash apparatus 101. In one embodiment, the motor mount plate 139 may be a substantially square plate formed from metal, and may include multiple fastener apertures 141 configured to receive fasteners for attaching the motor mount plate 139 to the trolley. As is shown, the motor mount plate 139 may further include a plurality of additional apertures 143 to facilitate cooling or ventilation of the rotation motor when in use, as well as for draining any fluid that may leak from or otherwise be discharged from the arm assembly inlet 131 and/or fluid distribution conduit of the car wash apparatus.

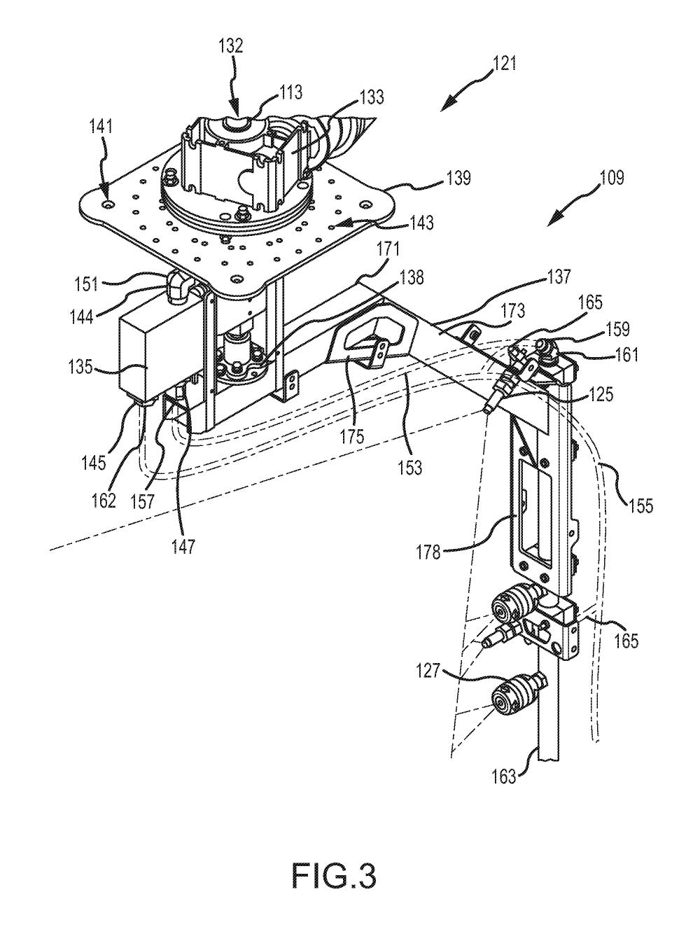

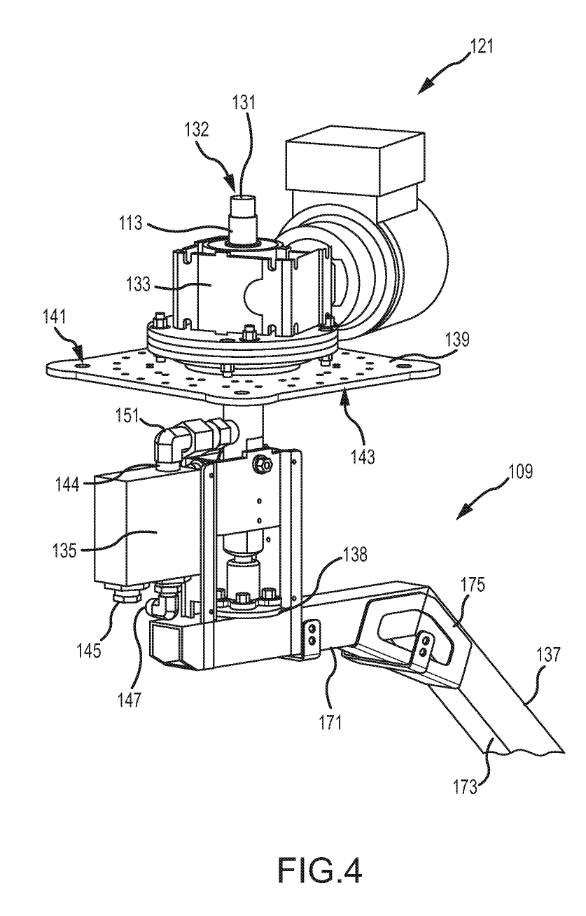

Referring to FIGS. 3 and 4, the arm assembly inlet 131 may be configured for fluid communication with a fluid passage that extends from the arm assembly inlet 131 through the arm shaft 113 to a diverter valve inlet 144 of a diverter valve 135. The fluid passage may include a concentric fluid passage or conduit 132 that extends from the arm assembly inlet 131 through the arm shaft 113 in the motor assembly 133, and a second L-shaped portion 151 that extends from the concentric fluid conduit 132 that terminates at a connection with the diverter valve inlet 144. In one implementation, the hollow arm shaft 113 may itself act as part of the fluid conduit 132. As best shown in FIG. 4, the L-shaped portion 151 of the fluid passage may be a pipe, tube, hose, or other fluid distribution mechanism.

As best shown in FIGS. 3 and 4, the diverter valve 135 may have a housing through which an inlet 144 and two outlets 145, 147 extend and which houses a combination of valves. As is shown, the diverter valve inlet 144 may be provided on the top surface of the diverter valve 135 and two diverter outlets 145, 147 may be provided on the bottom surface of the diverter valve 135. Other configurations are possible.

The two diverter valve outlets 145, 147 may have different configurations. For example, the diverter valve 135 may include a high-pressure outlet 147 for expelling high-pressure fluid and a low-pressure outlet 145 for expelling low-pressure fluid. As shown, the high-pressure outlet 147 may be coupled to a high-pressure fluid distribution conduit 153 (or hose) configured to distribute high-pressure fluid to each of the high-pressure nozzles 127. The high-pressure conduit (or hose) 153 may include a first end 157 that is coupled to the high-pressure outlet 147 of the diverter valve 135 and a second end 159 that is coupled to a fluid inlet 161 of a vertical fluid distribution pipe 163 on the spray arm 109 that is fluidly coupled to each of the high-pressure nozzles 127.

The low-pressure outlet 145 may be attached to a low-pressure fluid distribution conduit (or hose) 155 configured to distribute low-pressure fluid to each of the low-pressure nozzles 125. As shown in FIG. 4, the low-pressure conduit 155 may include a single inlet end 162 that is attached the low-pressure outlet 145 of the diverter valve 135, and may branch as a manifold to form several fluid outlets 165 that are each fluidly coupled to a low-pressure nozzle 125 of the nozzle assembly 123. The high and low-pressure fluid distribution conduits 153, 155 may be any type of fluid distribution member including, but not limited to, hoses, tubes, and so on. In some embodiments, the low-pressure conduit may be a hose wrapped around or attached to the vertical distribution pipe 163.

The vertical distribution pipe 163 may be supported by a mounting arm 137 attached to the bottom of the arm shaft 113, and accordingly, may be rotated with the mounting arm 137 about the longitudinal axis 111 of the arm shaft 113. The mounting arm 137 may include a horizontal bar 171 that is fastened to the base of the arm shaft 113 and an angled bar 173 joined to the free end of the horizontal bar 171. In one embodiment, the angled bar 173 may extend away from the diverter valve 135 at an angle relative to the horizontal bar 171. A bracket 175 may be securely fixed to the horizontal bar 171 and angled bars 173 at their interface to reinforce the joint structure of the mounting arm 137. As shown in FIG. 3, the bottom end of the angled bar 173 may be secured to a vertical mounting bracket 178, which may be securely fastened to the top end portion of the vertical fluid distribution pipe 163.

The nozzle assembly 123 may include a plurality of low and high-pressure nozzles 125, 127 that are supported by the vertical fluid distribution pipe 163. In one embodiment, the vertical fluid distribution pipe 163 may have a tubular configuration and define a fluid passage that is fluidly coupled to each of the high-pressure nozzles 127. Accordingly, the high-pressure fluid from the high-pressure outlet 147 of the diverter valve 135 may be directed through the high-pressure conduit 153 into the fluid passage of the vertical fluid distribution pipe 163, and expelled through the high-pressure nozzles 127.

The low-pressure nozzles 125 may be attached to the exterior of the vertical fluid distribution pipe 163 at spaced intervals. For example, the low-pressure nozzles 125 may be clamped or otherwise fastened to the exterior of the vertical fluid distribution pipe 163. Low-pressure fluid from the low-pressure outlet 145 of the diverter valve 135 may be directed through the low-pressure conduit 155, which may be connected with the low-pressure nozzles 125 in a manifold fashion, and expelled through the low-pressure nozzles 125.

The number of high or low-pressure nozzles 127, 125 may vary according to different embodiments. For example, the number of high or low-pressure nozzles 127, 125 provided on the vertical fluid distribution pipe 163 may depend on the amount of soap solution required to adequately coat the car, the amount of high-pressure spray required to adequately wash off the presoak solution, the path of the arm assembly 109 around the vehicle 105, the spray patterns of the high and low-pressure nozzles 127, 125, and so on. In one embodiment, the arm assembly 109 may include more high-pressure nozzles 127 and fewer low-pressure nozzles 125. Similarly, the spacing between the nozzles 127, 125 may vary according to different embodiments. In one particular embodiment, the low-pressure nozzles 125 may be spaced further apart than the high-pressure nozzles 127.

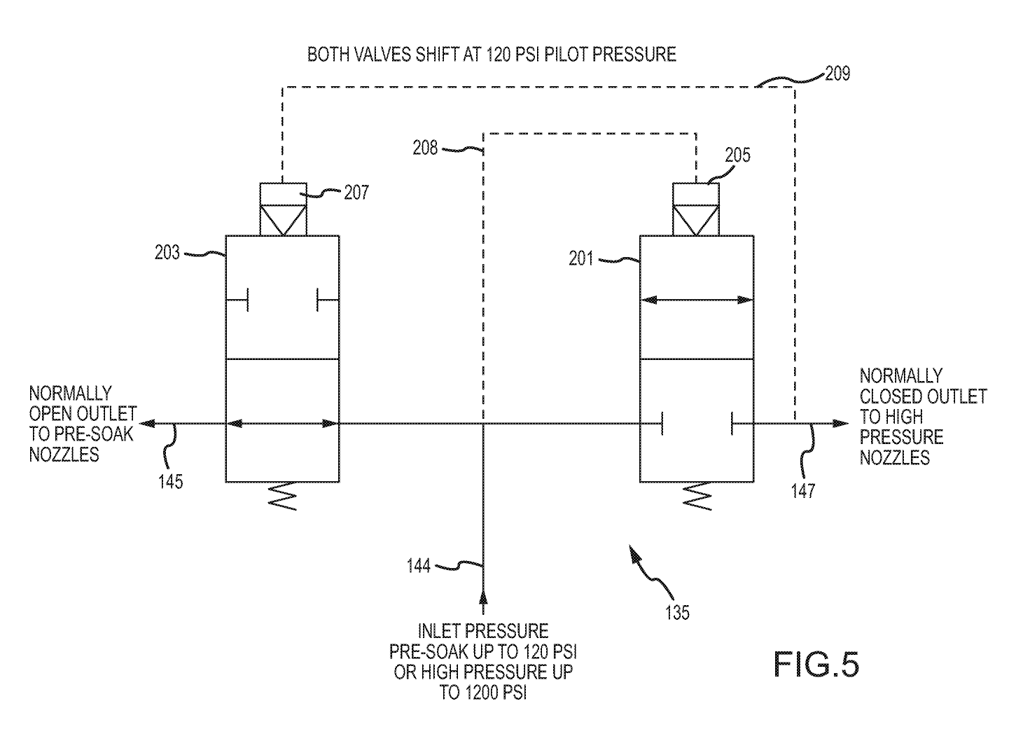

A schematic diagram of the operation of one embodiment of a diverter valve 135 that may be used in conjunction with the arm assembly shown in FIGS. 1-4 is shown in FIG. 5. As shown in FIG. 5, the diverter valve 135 may include two valves: a first valve 201 that is fluidly coupled to the high-pressure outlet 147 and a second valve 203 that is fluidly coupled to the low-pressure outlet 145. The first valve may be normally closed to prevent fluid from flowing through the high-pressure outlet 147 unless the fluid entering the inlet 144 of the diverter valve 135 is a high-pressure fluid. In contrast, the second valve 203 may be normally open to allow fluid to flow through the low-pressure outlet 145 unless the fluid entering the inlet 144 of the diverter valve 135 is a high-pressure fluid.

This switching operation between the low-pressure outlet 145 and the high-pressure outlet 147 may be achieved by using valves 201, 203 with pilot ports 205, 207 that control whether the valves 201, 203 are open or closed based upon fluid pressure feedback. At low fluid pressure on the pilot ports 205, 207, the valves 201, 203 remain in their normal states, i.e., normally open for valve 201 and normally closed for valve 203. As shown in FIG. 5, a branch flow passage 208 from the fluid inlet 144 supplies fluid to the pilot port of the normally-closed valve 201. Because the fluid pressure is low, the normally-closed valve 201 remains closed. Low-pressure fluid flow from the inlet port 144 to the inlet of the normally-closed valve 201 is prevented from flowing therethrough to the high-pressure outlet 147. However, low-pressure fluid flow from the inlet port 144 to the inlet of the normally-open valve 201 flows through the normally open valve 201 to the low-pressure outlet 145 for distribution to the low-pressure nozzles 125.

When a high-pressure fluid is alternately received at the inlet port 144, high pressure fluid flows to the pilot port 205 for the normally-closed valve 201 and provides sufficient pressure to open the valve 201. Fluid thus begins to flow through the normally-closed valve 201, now in its open position, to the high-pressure outlet 145 for distribution to the high-pressure nozzles 127. As shown in FIG. 5, a fluid feedback loop 209 runs from the high-pressure outlet 147 of the normally-closed valve 201 to the pilot port 207 of the normally-open valve 203. The high pressure on the pilot port 207 causes the normally-open valve 203 to close. Thus, the high-pressure fluid from the inlet 144 of the diverter valve 135 is prevented from flowing through the normally-open valve 203 to the low-pressure outlet 145. When the high-pressure flow stops, the normally-closed valve 201 has reduced or no fluid pressure at the pilot port 205 and thus returns to a closed position. Once the normally-closed valve 201 is in the closed position, there is no fluid flow through the feedback loop 209 to the normally-open valve 203. With no fluid pressure on the pilot port 207 of the normally-open valve 201, it returns to its open position and allows flow of low pressure fluid therethrough.

In this way, the diverter valve 135 is able to automatically switch between separate outputs for low-pressure and high-pressure fluids from a single input source without any additional input control. As low-pressure fluid flows through the diverter valve 135, the normally closed first valve 201 remains closed and the normally-open second valve 203 remains open. The second normally-open valve 203 remains open to allow the low-pressure fluid through the valve 203 and out the low-pressure outlet 145 of the diverter valve 135. In contrast, when high-pressure fluid flows through the diverter valve 135, the first normally-closed valve 201 opens and the second normally-open valve 203 closes. Thus, when a high-pressure fluid input is placed upon the pilot ports 205, 207, the valves 201, 203 switch from a normally-closed to open configuration and from a normally-open to closed configuration, respectively. Accordingly, the fluid flow path to the low-pressure outlet 145 is blocked, and the high-pressure fluid is transmitted through the high-pressure outlet 147 of the diverter valve 135. Further, because there is only a single fluid input, the design of the rotational mount of the spray arm 137 is greatly simplified. A single fluid passage through the arm shaft 113 is all that is required.

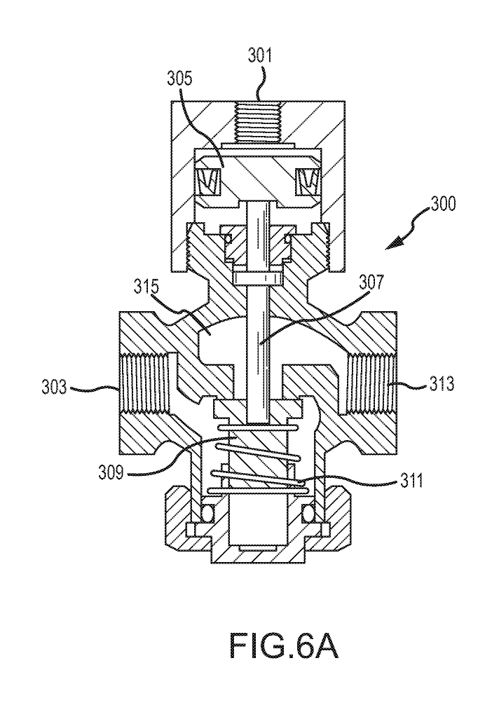

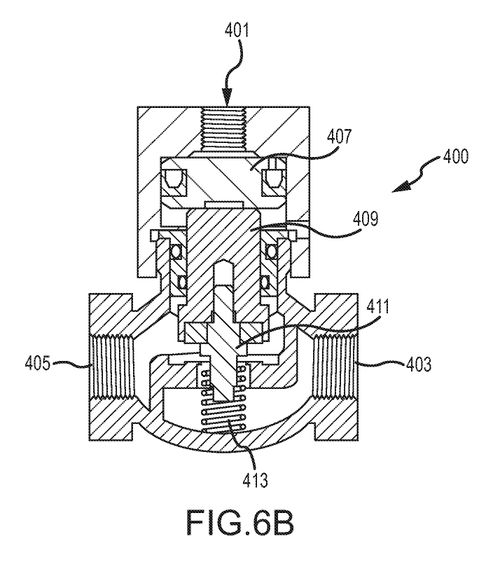

FIG. 6A illustrates an exemplary hydraulically-actuated, normally-closed poppet valve 300 that may be used for the first normally-closed valve 205 connected to the high-pressure outlet 147 in the embodiment shown in FIG. 5. The poppet valve 300 may include a pilot port 301, an inlet port 303 fluidly communicating with the diverter valve inlet 144, and an outlet port fluidly communicating with the high-pressure outlet 147 of the diverter valve 135. Additionally, the poppet valve 300 may include a movable element or piston 305, a stem 307 connected to the piston 305, a poppet 309 connected to the stem 307 for blocking fluid flow, and a biasing spring 311 for biasing the piston 305 against the pilot port 301 and for biasing the poppet 309 to close the fluid path between the fluid inlet 309 and the fluid outlet 313.

FIG. 6B illustrates an exemplary hydraulically actuated normally-open poppet valve 400 that may be used for the second normally-open valve 207 connected to the low-pressure outlet 145 in the embodiment shown in FIG. 5. The poppet valve 400 may include a pilot port 401, an inlet port 403 fluidly communicating with the diverter valve inlet 144, and an outlet port 405 fluidly communicating with the low-pressure outlet 145 of the diverter valve 135. The poppet valve 400 may also include a movable element or piston 407, a poppet 409 connected to the piston 407 for blocking fluid flow, a stem 411 connected to the poppet 409, and a biasing spring 413 for biasing the piston 407 against the pilot port and so that the fluid path between the fluid inlet port 403 and the fluid outlet port 405 remains open.

In one embodiment, the first normally-closed valve 205 of the diverter valve 135 may be a normally-closed poppet valve 300, as shown in FIG. 6A, in which fluid pressure pushes the piston 305 off the pilot port 301, which translates into linear force of the stem 307 and poppet 309 against the biasing spring 311 to open the fluid path 315 between the fluid inlet 303 and fluid outlet 313 and allow a flow path between the diverter valve inlet 144 and the high-pressure outlet 147. The second normally-open valve 207 may be a normally open poppet valve 400 as shown in FIG. 6B, in which the fluid pressure at the pilot port 401 pushes the piston 407 against the poppet 409 to resist the biasing spring 413 and move the poppet 409 into a position to block the flow path between the diverter valve inlet 144 and the low-pressure outlet 145.

When pressure from a high-pressure fluid is applied to the pilot port 301 of the normally-closed poppet valve 300, the fluid pressure at the pilot port 301 overcomes the biasing force of the spring 311 to depress the piston 305 and push the poppet 309 to an open position, thus creating a flow path between the fluid inlet 309 and fluid outlet 311 of the normally-closed poppet valve 300. As such, the flow path between the fluid inlet 144 of the diverter valve 135 to the high-pressure outlet 147 remains open. At the same time, a portion of the fluid flow from the high-pressure outlet 147 is directed to the pilot port 401 of the normally-open poppet valve, thereby forcing the piston 407 and the poppet 409 within the valve 400 to a closed position, blocking fluid flow from the low-pressure outlet 145. In contrast, when pressure from a low-pressure fluid is applied to the pilot port 301 the normally-closed poppet valve 300, the force is insufficient to counteract the biasing force of the spring 311. Accordingly, the piston 305 remains biased against the pilot port 301 and the poppet 309 is positioned in the fluid path between the fluid inlet 309 and fluid outlet 311 of the normally-closed poppet valve 300 to block fluid flow. As such, the flow path between the fluid inlet 144 of the diverter valve 135 to the high-pressure outlet 147 is blocked. At the same time, the poppet 409 of the normally-open poppet valve 400 is in an unseated position because there is no pressure on the pilot port 401 of the normally-open poppet valve 400 because there is no flow through the normally closed poppet valve 300 to enter the feedback loop 209 and exert pressure on the pilot port 401. Thus, a low-pressure fluid flow results in fluid flow between the fluid inlet 144 of the diverter valve 135 to the low-pressure outlet 145 and a high-pressure fluid at the fluid inlet of the diverter valve 135 exits the high-pressure outlet 147.

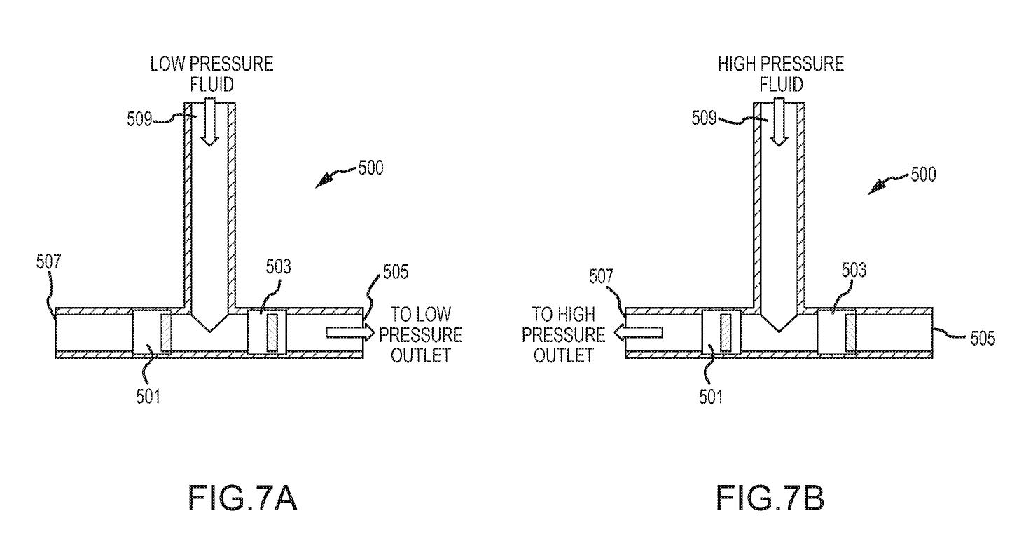

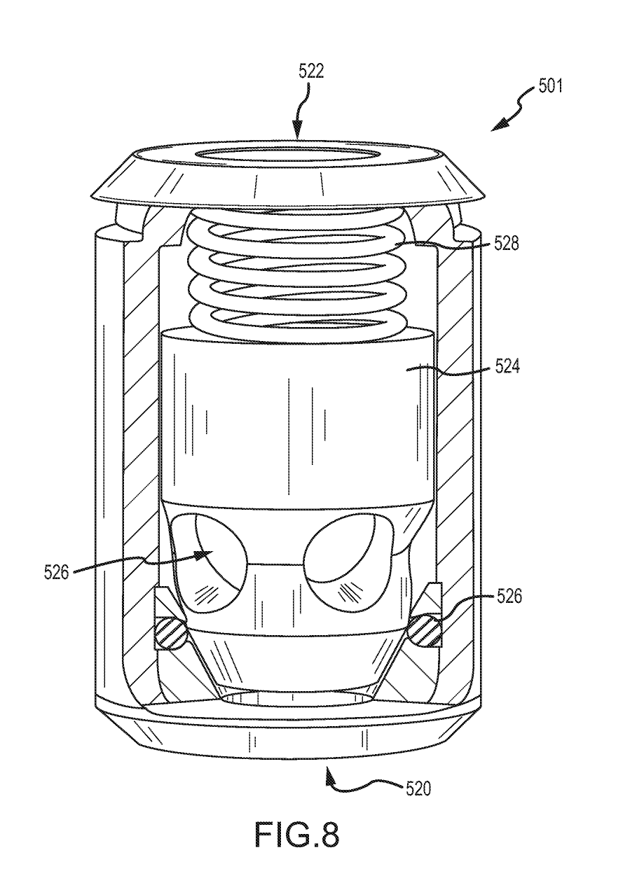

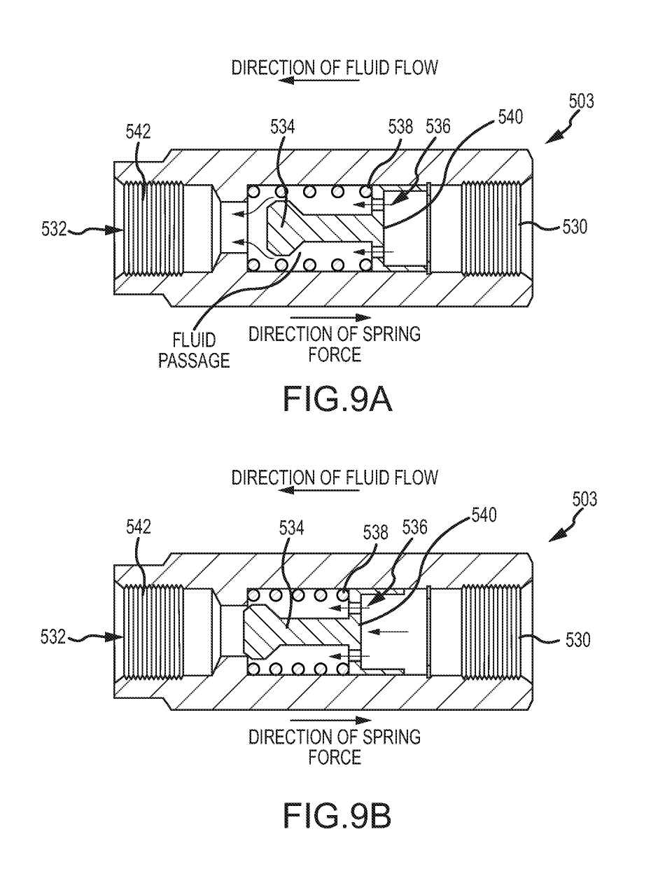

A schematic diagram of the operation of another embodiment of a diverter valve 500 that may be used in conjunction with the spray arm assembly shown in FIGS. 1-4 is shown in FIGS. 7A and 7B. FIG. 7A schematically illustrates the flow of a low-pressure fluid through the diverter valve 500 and FIG. 7B schematically illustrates the flow of a high-pressure fluid through the diverter valve 500. As shown in FIGS. 7A and 7B, the diverter valve 500 may include two valves: a check valve 501 that is fluidly coupled to the high-pressure outlet 507 and a burst or velocity valve 503 that is fluidly coupled to the low-pressure outlet 505. An exemplary check valve 501 is illustrated in FIG. 8 and an exemplary burst valve (or velocity fuse) 503 is illustrated in FIGS. 9A and 9B.

Referring to FIGS. 7A and 7B, in one embodiment, the check valve 501 may be normally closed to prevent fluid from flowing through the high-pressure outlet 507 unless the fluid entering the inlet 509 of the diverter valve 500 is a high-pressure fluid. In contrast, the burst valve (or velocity fuse) 501 may be normally open to allow fluid to flow through the low-pressure outlet 505 unless the fluid entering the inlet 509 of the diverter valve 500 is a high-pressure fluid. As shown in FIG. 7A, when low-pressure fluid flows enters the diverter valve 500 via the inlet 509, the check valve 501 remains closed and the burst valve (or velocity fuse) 503 remains open. As such, the low-pressure fluid may be directed through the low-pressure outlet 505 of the diverter valve 500. In contrast, when high-pressure fluid enters the diverter valve 500, as shown in FIG. 7B, the burst valve (or velocity fuse) 503 may close, creating a high-pressure that opens the check valve 501. Accordingly, the high-pressure fluid may be transmitted through the high-pressure outlet 507 of the diverter valve 500.

FIG. 8 illustrates an exemplary check valve 501 that may be used in conjunction with the embodiment shown in FIGS. 7A and 7B. Referring to FIG. 8, the check valve 501 may include a fluid inlet 520 in fluid communication with the diverter valve inlet 144, a fluid outlet 522 in fluid communication with the high-pressure diverter valve outlet 507, a piston 524, a seal 526, and a biasing spring 528 configured to bias the piston against the seal. As discussed above, the check valve 501 may be a normally closed valve. Accordingly, when low-pressure fluid is directed through the inlet 520 of the check valve 501, the biasing spring 528 may remain in an uncompressed state and continue to bias the piston 524 against the seal to prevent fluid flow through the valve 501 and through the high-pressure outlet 507 of the diverter valve 500. In contrast, when a high-pressure fluid is directed through the inlet 520 of the check valve 501, the fluid pressure depresses the piston 524 away from the seal 526, thereby permitting fluid flow through the check valve 501 and through the high-pressure outlet 507 of the diverter valve 500. In one embodiment, the high-pressure fluid may flow through the holes 526 defined in the piston 524 and through the body of the piston 524 to the fluid outlet 522.

FIGS. 9A and 9B illustrate an exemplary burst valve (or velocity fuse) 503 that may be used in conjunction with the diverter valve 500 shown in FIGS. 7A and 7B. As shown in FIGS. 9A and 9B, the burst valve (or velocity fuse) 503 may include a fluid inlet 530, a fluid outlet 532, a moveable poppet 534 with apertures 536, and a biasing spring 538 for biasing the poppet 534 toward the inlet 530 so that fluid may flow through apertures 536 in the poppet 534 and continue through the fluid passage to the outlet 532. As discussed above, the burst valve (or velocity fuse) 503 may have a normally open configuration, so that spring 538 continues to bias the poppet 534 away from the outlet 532 to allow fluid to flow through the valve 503. As shown in FIG. 9A, when a low-pressure fluid enters the valve 503 through the fluid inlet 530, the biasing force of the spring 538 counteracts the pressure of the water on the face 540 of the poppet 534 to prevent the poppet from being displaced toward the fluid outlet 532. Accordingly, low-pressure fluid is directed through the apertures 536 in the poppet 534 to the outlet passage 542 of the burst valve (or velocity fuse) 503 and out the low-pressure outlet 505 of the diverter valve 500. As shown in FIG. 9B, when a high-pressure fluid enters the valve 500 through the fluid inlet 509, the pressure of the fluid on the face 540 of the poppet 534 overcomes the biasing force of the spring 538 to push the poppet 534 toward the outlet passage 542, thereby blocking the outlet passage 542 and preventing the high-pressure fluid from exiting through the outlet 532 of the burst valve (or velocity fuse) 503. In this case, high-pressure fluid is prevented from flowing through the low-pressure outlet 505 of the diverter valve 500.

In some embodiments, the burst valve (or velocity fuse) may include a bleed hole for preventing a pressure lock situation. The bleed hole may be, for example, a small hole provided in the valve that gradually decreases the fluid pressure inside the body of the burst valve until the burst valve (or velocity fuse) is opened. Accordingly, if the check valve fails to open, the bleed hole may serve to release the fluid pressure within the valve and prevent combustion.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although the disclosed embodiments have been described with a certain degree of particularity, it is understood the disclosure has been made by way of example and changes in detail or structure may be made without departing from the spirit of the invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims

What is claimed is:

1. An apparatus for washing a vehicle comprising
a movable platform;
a spray arm assembly mountable to the movable platform, the spray arm assembly including at least one high-pressure nozzle and at least one low-pressure nozzle; and
a diverter valve comprising
an inlet configured to alternatingly receive a high-pressure fluid and a low-pressure fluid;
a first outlet configured to distribute the high-pressure fluid;
a second outlet configured to distribute the low-pressure fluid;
a first valve between the inlet and the first outlet that changes from a closed state to an open state upon a change in fluid pressure; and
a second valve that changes from an open state to a closed state upon the change in fluid pressure.

2. The apparatus of claim 1, wherein the first outlet is fluidly coupled to the at least one high-pressure nozzle and the second outlet is fluidly coupled to the at least one low-pressure nozzle.

3. The apparatus of claim 1, wherein the first valve further comprises a normally-closed valve fluidly coupled to the first outlet and the second valve further comprises a normally-open valve fluidly coupled to the second outlet.

4. The apparatus of claim 3, wherein the normally-closed valve is configured to close the first outlet when low-pressure fluid is received through the diverter valve inlet.

5. The apparatus of claim 3, wherein the normally-open valve is configured to close the second outlet when high-pressure fluid is received through the diverter valve inlet.

6. The apparatus of claim 3, wherein the normally-closed valve comprises a normally-closed poppet valve and the normally-open valve comprises a normally open poppet valve.

7. The apparatus of claim 3, wherein the normally-closed valve comprises a check valve.

8. The apparatus of claim 3, wherein the normally-open valve comprises a burst valve.

9. The apparatus of claim 1, wherein
the spray arm assembly is rotatably mountable to the movable platform about a hollow shaft that forms or houses a fluid conduit; and
the inlet of the diverter valve is in fluid communication with the fluid conduit.

10. The apparatus of claim 1, wherein the first outlet is further configured for attachment to a fluid distribution member for distributing fluid to a high-pressure nozzle and the second outlet is further configured for attachment to a fluid-distribution member for distributing fluid to a low-pressure nozzle.

11. The diverter valve of claim 10, wherein the high-pressure fluid is water.

12. The diverter valve of claim 10, wherein the low-pressure fluid is a pre-soak solution.

13. A diverter valve comprising
a valve body comprising an inlet configured to alternatingly receive a high-pressure fluid and a low-pressure fluid;
a first outlet configured to distribute high-pressure fluid;
a second outlet configured to distribute low-pressure fluid;
a first valve fluidly coupled to the inlet and the first outlet; and
a second valve fluidly coupled to the inlet and the second outlet, wherein
the first valve is configured to close when the second valve is open and the second valve is configured to close when the first valve is open.

14. The diverter valve of claim 13, wherein the first valve is configured to close when low-pressure fluid is received through the inlet and the second valve is configured to close when high-pressure fluid is received through the inlet.

15. The diverter valve of claim 14, wherein
the first valve has a first pilot port configured to receive fluid that causes the first valve to change between an open configuration and a closed configuration upon a change in pressure of the fluid at the first pilot port;
the second valve has a second pilot port configured to receive fluid that causes the second valve to change between an open configuration and a closed configuration upon a change in pressure of the fluid at the second pilot port; and
the diverter valve further comprises
a branch fluid channel in fluid communication with the inlet and the first pilot port; and
a fluid feedback loop channel in fluid communication with the first outlet and the second pilot port.

16. The diverter valve of claim 13, wherein
the first valve further comprises a normally-closed poppet valve coupled to the first outlet that is configured to close when a low-pressure fluid is received at the inlet and open when a high-pressure fluid is received at the inlet; and
the second valve further comprises a normally-open poppet valve fluidly coupled to the second outlet that is configured to open when a low-pressure fluid is received at the inlet and close when a high-pressure fluid is received at the inlet.

17. The diverter valve of claim 13, wherein
the first valve further comprises a normally-closed check valve coupled to the first outlet that is configured to close when a low-pressure fluid is received at the inlet and open when a high-pressure fluid is received at the inlet; and
the second valve further comprises a normally-open burst valve fluidly coupled to the second outlet that is configured to open when a low-pressure fluid is received at the inlet and close when a high-pressure fluid is received at the inlet.

18. A diverter valve comprising
a valve body comprising a valve body inlet configured to alternatingly receive a high-pressure fluid and a low-pressure fluid;
a first outlet configured to distribute high-pressure fluid;
a second outlet configured to distribute low-pressure fluid;
a first valve including a first valve inlet fluidly coupled to the valve body inlet and a first valve outlet fluidly coupled to the first outlet; and
a second valve including a second valve inlet fluidly coupled to the valve body inlet and a second valve outlet fluidly coupled to the second outlet;
wherein the first valve is configured to open and the second valve is configured to close if a high-pressure fluid is received at the valve body inlet; and
the first valve is configured to close and the second valve is configured to open if a low-pressure fluid is received at the valve body inlet.

19. The diverter valve of claim 18, wherein the first valve is configured to divert fluid to the second valve inlet if a low-pressure fluid is received at the valve body inlet.

20. The diverter valve of claim 18, wherein the second valve is configured to divert fluid to the first valve inlet if a high-pressure fluid is received at the valve body inlet.
